(19) United States
(12) Patent Application Publication
(10) Pub. No.: US 2022/0167066 A1
(43) Pub. Date: May 26, 2022

(54) SHORT VIDEO COPYRIGHT STORAGE METHOD BASED ON BLOCKCHAIN AND EXPRESSION IDENTIFICATION

(71) Applicant: Communication University of Zhejiang, Hangzhou City (CN)

(72) Inventors: Dingguo YU, Hangzhou City (CN); Yang YANG, Hangzhou City (CN); Nan CHEN, Hangzhou City (CN); Yongjiang QIAN, Hangzhou City (ZJ)

(21) Appl. No.: 17/344,782

(22) Filed: Jun. 10, 2021

(30) Foreign Application Priority Data
Nov. 26, 2020 (CN) 202011347975.3

(51) Int. Cl. H04N 21/835; G06F 21/16; H04L 9/32; G06N 3/04

(52) U.S. Cl. CPC H04N 21/835; G06F 21/16; G06F 2221/0737; G06N 3/04; H04L 2209/38; H04L 9/3239

(57) ABSTRACT

A short video copyright storage method based on blockchain and expression identification, wherein first, the video key information of face short videos is calculated by an method of convolution neural network based on visual priority rules, and second the key information is stored in an alliance blockchain in the form of log files to complete the digital copyright storage of short videos. The method includes: authenticating alliance chain member nodes, which can store the short video digital copyright and perform other operations after being authenticated; extracting key information of face short videos; calculating the feature vector of key information through a deep learning method; enhancing the calculation of the feature vector to improve the efficiency of certificate storage; generating JSON file of digital copyright identification tag value of face short video.

### CROSS REFERENCE TO RELATED APPLICATION(S)

This patent application claims the benefit and priority of Chinese Patent Application No. 202011347975.3, filed on Nov. 26, 2020, the disclosure of which is incorporated by reference herein in its entirety as part of the present application.

### TECHNICAL FIELD

The present disclosure relates to the field of short video digital copyright storage and confirmation by blockchain, intelligent contract and deep learning technology, in particular to a short video copyright storage method based on blockchain and expression identification.

### BACKGROUND ART

In recent years, the digital copyright protection of short videos has become increasingly popular. The media streams circulating on the radio and television network, the traditional Internet and the 5G mobile network, such as music, MV, live broadcast, etc., have copyright. The copyright of the face short videos uploaded by users from Everbright Securities on some short video platforms will be easily infringed when it involves value transfer or commercialization. Up to now, the number of users in digital publishing industry in China has reached more than 1.8 billion, and the overall revenue scale of the digital copyright industry has reached more than 700 billion yuan. With the rapid development of digital media copyright industry, many copyright problems are also exposed, such as the inefficiency of traditional digital copyright protection schemes, the high degree of centralization caused by the dependence of protection schemes on centralized groups, the easy tampering of protected digital copyright information, and the long and difficult time of defending rights and obtaining evidence after the infringement and piracy of digital short video works. The alliance chain in blockchain technology can play a certain role in confirming the digital copyright storage of face short video media.

The alliance chain technology in blockchain is applied in the field of short video digital copyright storage, which can provide each member node in its alliance with a distributed account book for storing information. This account book can store short video digital copyright information. Because the blockchain itself has tamper-proof characteristics, the records in the account book cannot be tampered without considering the possibility of Hash collision. Because once there is any slight change in the information, based on the characteristics of Hash cryptography method, the final result of the whole account book is a huge modification.

Hash method is a one-way cryptographic method, which is characterized in that it can map a plaintext into a ciphertext through encryption calculation, and this mapping is irreversible. That is to say, after any information is calculated by Hash method, the information before encryption cannot be deduced from the calculated result, that is, it can only be encrypted but not decrypted. Two identical plaintext strings will generate the same ciphertext string after Hash encryption, but if there is a difference between the two plaintext strings, the ciphertext strings generated will be completely different and irregular. Therefore, for the key information of digital copyright of short videos, through Hash calculation, the information can be completely labeled with a unique, non-reversible identifier consisted of messy characters.

Visual priority rules in deep learning technology represent the most special visual priority rules in the human brain signal processing mechanism. Human beings have the instinct to obtain information by browsing pictures or words quickly. In the process of obtaining information, unconsciously, the parts that need to be focused on will be “anchored”, that is, paying attention to the focus of attention. This mode can effectively avoid redundant information on the basis of visually obtaining more key information. In the present disclosure, the visual priority rule is introduced based on the existing convolutional neural network, which is very helpful for the feature extraction of facial expression key points. First, convolution neural network collects different parts of face semantic sub-features and hierarchical structure features through its own features, and then characterizes complex objects, in which all sub-features are stored in feature vectors of each independent level in groups. Second, in the convolutional neural network based on visual priority rules, the sub-features in each group are processed in parallel. Finally, the visual priority rule module can adjust the importance of each sub-feature by adjusting the weight.

The research on the application of blockchain technology in the field of digital copyright protection of short videos has different emphases from different perspectives. However, at present, the application of blockchain technology in a specific application of digital copyright storage of short videos has not been summarized, and most of the research still stays at the research level. In 2018, Propaganda Department made deployment arrangements for promoting the construction of county-level media integration centers nationwide, which required that the county-level media integration centers be basically covered nationwide by the end of 2020. Each county-level media integration center group relying on the provincial media platform is equivalent to a media integration alliance with the provincial media integration center as the center and the county-level media integration center as the branch. This characteristic makes the organizational structure a typical application scenario of blockchain technology for short video digital copyright protection: the provincial media integration center has the authority to coordinate the activities such as media resources storage of county-level media integration centers, and the county-level media integration center can use the short video copyright storage method based on blockchain and facial expression identification proposed by the present disclosure to carry out alliance chain storage of short video digital copyright.

### SUMMARY

Aiming at the defects of the prior art, the present disclosure provides a short video copyright storage method based on blockchain and expression identification.

The present disclosure can be applied to a short video service platform, and the service platform provides a work protection channel for short video producers. Now short video has become an important presentation form of media news, so that the present disclosure establishes alliance blockchain (hereinafter referred to as alliance chain) based on the typical application scenario of a provincial media integration center. In this scenario, lower-level institutions (such as county-level media center) can carry out short video digital copyright storage based on the alliance chain. As a member node in the alliance chain, the county-level financial media center must pass the certification of the provincial media integration center, that is, it can be the provider of short video digital resources. Member nodes use this system to authenticate first, and the authenticated member nodes can use this system to store short video digital copyright.

Convolutional neural network calculation based on visual priority rule collects different information and hierarchical structure features of 30 key feature points of human face through its own features, so as to characterize these information and features. All sub-features will be automatically grouped by the system and automatically saved in an independent feature vector. The calculation of visual priority rules is operated separately for each group. It is first assumed that there is a feature in each spatial position of a feature group. Second, the original features in the feature group perform average pooling operation. Then, the global features in the feature group and the original features are subjected to integration dot product operation to obtain the independent coefficients corresponding to each feature and normalize them. Next, parameters are introduced, the normalized values are scaled and moved, and the SIGMOID function is activated. Finally, the activated normalized value and the original feature are subjected to dot product operation to obtain the enhanced feature vector.

According to the method, the enhanced feature vector data of the sampling 30 key points of the identified face are written by a written field into JSON files for storage, and the face key point identification prolongs the operation time according to the increase of the number of people detected. According to the present disclosure, the problems of identification efficiency and practical application requirements are considered. The key point identification not only ensures the relative unique effect of access information, but also ensures that the data quantity cannot be too large. The data collection of the neck, cervico and other parts need not be considered temporarily for the storage requirements of the blockchain.

In order to improve the usability of the system, the deep learning method is adopted to extract the key frames. The JSON file of the key frame enhanced feature vector of the short video file is used as the main basis for video storage and confirmation, and the Hash value of the JSON file is stored in the blockchain as the unique identifier of the file. If the length of a video file to be stored exceeds the specified duration (5 min), the system will automatically divide it into a single short video group with a duration of 5 min. The elements in the group will output logs respectively, and the total Hash value will be calculated in the form of Merkel tree as the Merkel root value of the long video to be written into the block.

A short video copyright storage method based on blockchain and expression identification comprises the steps of:

Step 1: identifying facial expressions in face short videos using convolution neural network method based on visual priority rules, uploading short video works by a client, extracting facial expression features of the whole short video, and generating JSON file of a content tag value log capable of uniquely identifying the short video;

Step 2: using the short video digital copyright storage method based on blockchain and facial expression identification to store the JSON file of the content tag value log of the short video generated in step 1 into the alliance blockchain;

Step 3: sending a registration request to the first node (node 1) in the alliance blockchain responsible for collecting registration applications, joining unconfirmed registration lists and building blocks, wherein the first node (node 1) issues a broadcast request for registration verification to the whole network;

Step 4: after the available nodes of the whole network receive the request from the first node (node 1), calculating the hash value of the new block first, and then issuing the broadcast request for hash value check to the whole network;

Step 5: after the available nodes of the whole network receive the hash value of the new block calculated in step 4, checking the hash value first, then broadcasting its own check result to the whole network, storing and registering after being confirmed for the rule by the fault-tolerant method in the whole network, and finally returning the results to the client.

The method further comprises: prior to step 1, the alliance chain members log in for authentication. The alliance chain members log in for authentication, specifically comprising:

the member nodes of the alliance chain initiate a login request to the alliance blockchain through their own unique private keys, if the login verification fails, the alliance blockchain automatically rejects the login request of the node to the trading system; if the login verification passes, the passing result is fed back to the node requesting authentication, and the node is allowed to enter the short video digital copyright storage system and initiate subsequent operations.

In step 1, visual attention is a unique brain signal processing mechanism of human beings. Human beings can quickly scan the whole world to obtain the areas that need to be focused on and shield the non-focused areas. Therefore, in the research of facial expression feature identification and extraction, giving priority to the visual feature mechanism of human eyeball (visual priority rule) can enhance the accuracy of facial expression feature extraction.

The multilayer and supervised learning mechanism of a convolutional neural network can reduce the memory occupied by deep network, and can be used for facial expression identification to characterize the complex object of facial expression.

The convolution neural network method based on visual priority rule adds a visual feature factor group after the convolution neural network has no independent layer. This factor group will assign a visual feature factor to each spatial position in each facial expression feature group. The size of this factor can control the importance weight of each independent feature in the facial expression feature group, so that any facial expression feature group can independently enhance its feature expression. First, convolution neural network collects different parts of face semantic sub-features and hierarchical structure features through its own features, and then characterizes complex objects, in which all sub-features are stored in feature vectors of each independent level in groups. Second, in the convolutional neural network based on visual priority rules, the sub-features in each group are processed in parallel. Finally, the visual priority rule module can adjust the importance of each sub-feature by adjusting the weight.

The calculation of visual priority rules is operated separately for each group, and it is first assumed that there is a feature in each spatial position of a feature group. Secondly, the original features in the feature group perform average pooling operation. Then, the global features in the feature group and the original features are subjected to integration dot product operation to obtain the independent coefficients corresponding to each feature and normalize them. Next, parameters are introduced, the normalized values are scaled and moved, and the SIGMOID function is activated. Finally, the activated normalized value and the original feature are subjected to dot product operation to obtain the enhanced feature vector. In the facial expression identification method of the convolution neural network based on visual priority rules, a residual identity block is added in order to increase identity mapping and enrich feature learning in the network, and the module is also combined with the visual priority rule module to ensure accurate extraction of subtle expressions and key expression features.

Identifying facial expressions in face short videos using convolution neural network method based on visual priority rules specifically comprises:

A) extracting the features of input data, setting a core as a convolution kernel of a convolutional neural network, whose size is X*Y, where X*Y represents the size of the convolution kernel, bias is its offset, fun is the activation function, input and output are input and output respectively, the sizes of input and output are both M*N, x represents the variable in which X increases from 0 in the size X*Y of the convolution kernel, and y represents the variable in which Y increases from 0 in the size X*Y of the convolution kernel. m represents the variable in which M increases from 0 in the size M*N of input and output, and n represents a variable in which n increases from 0 in the size M*N of input and output, wherein the proposed convolution operation formula is shown in formula (1);

output_{MN}=fun(Σₓ₌₀^{X-1}Σ_{y=0}^{Y-1}input_{m+y,n+x}core_{yx}+bias)

(0≤m≤M,0≤n≤N) (1)

B) performing average pooling operation, and setting the down-sampling layer as samplingdown, and using maximum pooling calculation, wherein the definition of maximum pooling is shown in formula (2);

sampling_{down}=max(sampling_{down-1}) (2)

where sampling_{down-1} represents the previous sampling layer of the down-sampling layer;

C) using the ELU activation function, controlling no saturation value of the activation function, and setting count as a constant, wherein the expression of the activation function is shown in formula (3);

$$E L U ( x ) = \{ \begin{matrix}x , x > 0 \\ count ( exp ( x ) - 1 ) , x \leq 0\end{matrix} ; \qquad ( 3 )$$

where ELU(x) represents the activation function based on the independent variable x, count in count(exp(x)-1) is a constant, and count in count(exp(x)-1) is used to control the saturation value of the activation function.

In step 1, the JSON file of the content tag value log of short videos consists of the following facial feature information: lip thickness, lip width, nose thickness, earlobe thickness, earlobe width, auricle width, nose height, lower eyelid width, eye corner width, eyelash width, right eyebrow width, eyebrow spacing, right sideburns height, hair color, middle hair width, head height, forehead color, left sideburns width, left eyebrows width, eyebrow tip height, eyebrow tail height, single-edged and double-edged eyelids, fish tail width, eyeball color, ear ornaments, nose width, philtrum depth, lip color, lower lip thickness and chin width, and its identification value consists of the following expression tags: fear, happiness, anger, disgust, sadness, surprise and normal expression.

In step 2, when Hash collision occurs, that is, when a suspected infringing video is detected, the short video digital copyright storage architecture based on blockchain proposed by the present disclosure takes video digital copyright key frames as the judgment basis, that is, the storage architecture changes the uplink storage of short video works into the uplink storage of key frame information, that is, the contents stored in the block, such as “Hash values of multiple videos”, are correspondingly changed into “Hash values of multiple key frames of one video”. In addition, the number of key frames is adjusted by setting thresholds, and different key frame selection bases are set based on different review standard mechanisms, so that the robustness and efficiency of the storage architecture are improved. The short video digital copyright storage architecture based on blockchain consists of a material production layer, a consensus contract layer, a business layer and a user layer from bottom to top, forming an architecture schematic diagram.

Using the short video digital copyright storage method based on blockchain and facial expression identification to store the JSON file of the content tag value log of the short video generated in step 1 into the alliance blockchain specifically comprises:

a) first, uploading original materials to an external client through a framework;

b) second, the facial expression identification mechanism of a convolutional neural network based on visual priority rule extracting key frame data, constructing a new block according to the key data list and issuing a broadcast to the whole network, and storing the personal information of a user and short video copyright information on the server simultaneously;

c) then, the client automatically initiating the application for registration into the chain and sending this application to the node 1 (the first node), after the node 1 (the first node) collects the application for registration, joins the unconfirmed registration and establishes the block, issuing a broadcast to the whole network and requesting the whole network to carry out registration verification;

d) after receiving the new block issued by the first node, the node 2 (the second node), the node 3 (the third node) and the node 4 (the fourth node), calculating the hash value of the new block and issuing a broadcast to the whole network to complete the pre-registration, respectively;

e) four nodes receiving and checking the hash value of the new block broadcasted by each other, respectively;

if the hash value of the received new block calculated by a certain neighbor node is equal to the hash value of the new block calculated by itself before issuing a broadcast, it is regarded as passing the registration check, otherwise it fails;

finally, each independent node broadcasts the verification result to other nodes after completing the registration verification of the hash value of the new block, according to Byzantine fault-tolerant method, each node working normally should receive and verify the registration verification information at least twice as much as the attack information, after each node receives the registration verification information of other nodes, the short video copyright registration confirmation letter is stored and is automatically sent to the client, and the primary registration process ends.

In the aspect of storage content of non-relational database blockchain, the present disclosure adopts deep learning technology to propose a facial expression identification mechanism of the convolution neural network based on visual priority rules under decentralized storage architecture distribution based on blockchain, provides an idea of extracting facial expression information with short video resources as materials, and reasonably selects key frames for data to extract information and store it into blockchain. The CNNVP mechanism provided by the present disclosure has obvious effect on extracting facial expression identification information, and the size of key frame images and key information files is far smaller than that of original video files. In the experiment, the JSON file generated after the key information is extracted from the original short video file of 75 MB has a size of about 1.2 MB. Analyzing the key information extraction strategy from the perspective of a distributed storage architecture greatly improves the availability of the blockchain storage system.

In step 4, the available nodes in the whole network are valid nodes, that is, nodes with long online time and low probability of problems, and the system automatically marks them as available nodes.

In step 4, the hash value of the new block is calculated by the hash function SHA256 method.

In step 5, the fault-tolerant method is a practical Byzantine fault-tolerant method with low computational complexity, which adopts signature verification and other methods to ensure anti-counterfeiting and anti-tampering message transmission and can reach consensus in the environment of “fewer evil nodes”. That is, the fault-tolerant method is a practical Byzantine fault-tolerant method.

Specifically, a short video copyright storage method based on blockchain and expression identification is provided, in which “blockchain” is represented by “the alliance blockchain” in the system, and “expression identification” is “a convolution neural network method based on visual priority” included in the present disclosure, which specifically comprises the following steps.

Step 1: The short video producer uploads the original video file of the face short video to be stored to the system through the client. The video is generally large in size, which is not conducive to direct storage of the blockchain. Therefore, the method of “a convolutional neural network based on visual priority rules” proposed by the present disclosure collects face information in all the pictures of the face short video through the characteristics of the method itself, and semantically analyzes the face information. Then, the complex object of face information is characterized by different parts and different features of the information, and then all the collected sub-features are stored in groups. Complete feature vectors are stored at each independent level.

Step 2: The feature vectors obtained in step 1 are stored in groups and then processed in parallel to improve the processing speed. Then, in order to adjust the importance level of each face part, the weight of the feature vectors is adjusted. The feature vectors stored in groups are operated independently. The present disclosure assumes that there is a feature value in the spatial position of any independent feature group, and then the original feature values in all independent feature groups perform average pooling operation to obtain global features.

Step 3: Dot product operation is performed on all the original features in the integration feature group of the global feature obtained in step 2 to obtain independent coefficients corresponding to each feature value, and normalize these coefficients. Finally, parameters are introduced, the normalized values are scaled and moved, and the SIGMOID function is activated. The activated normalized value and the original feature are subjected to dot product operation to obtain the enhanced feature vector.

Step 4: The enhanced feature vector value output in step 3 is input into a cross entropy loss function classifier, and finally seven types of facial expression tag identification values are output, which are: fear, happiness, anger, disgust, sadness, surprise and normal expression. The present disclosure stores the identified face key information data as the JSON file of the short video content tag value log by writing JSON fields.

Step 5: Aiming at the JSON file of the short video content tag value log which can uniquely identify the digital copyright of the short video output in step 4, the storage address pointer of the file will be obtained after uploading the file to the server, and the video copyright protection system will store the Hash value, the video index value and the corresponding file pointer of the video.

Step 6: The short video copyright storage method based on blockchain and expression identification proposed by the present disclosure adopts deep learning method to extract key frames in order to improve system availability, and takes the key frames of video files as the main basis for video storage and confirmation. The key frames have the characteristics of fast obtaining file information without comparing the original file content, so that their performance loss and physical resource loss can be ignored. According to the present disclosure, aiming at the copyright key data log file calculated by the method of “a convolution neural network based on visual priority rules”, first, the Hash value of the copyright key data log file is extracted by the SHA256 method, which is similar to the one-to-one correspondence between the database primary key and the file. Therefore, the Hash value of the log file is stored in the blockchain as the unique identifier of the file.

The short video copyright storage method based on blockchain and expression identification further comprises: prior to step 1, the alliance chain members log in for authentication. The member nodes of the alliance chain initiate a login request to the alliance blockchain through their own unique private keys. If the login verification fails, the alliance blockchain automatically rejects the login request of the node. If the login verification passes, the passing result is fed back to the node requesting authentication, and the node is allowed to enter and initiate subsequent operations.

In step 1, short video key face information is provided. Any short video work that can be normally circulated in broadcast TV network, mobile Internet and 5G network occupies a large digital space, so it is redundant to directly protect its own uplink copyright. Moreover, in view of the directionality of the present disclosure, the clearer the face information, the more preponderant the more storage details of the face picture in all frames of the video. The facial expression in the video is identified by the deep learning method, and the face information in the video is simply described, so as to make a reasonable prediction of the video content. Thereafter, the form of “short video key face information” is used as an effective parameter for the alliance chain to store data.

In step 2, feature vectors are provided. In order to improve the efficiency of distributed computing, each independent grouping calculated by convolution neural network based on visual priority rules can process its sub-features in parallel, but each sub-feature has slightly different importance when fully expressing facial expression information. Therefore, adjusting the sub-feature vector can modify its importance. Because the present disclosure first assumes that each feature group has an original feature, in order to accurately describe these features, the present disclosure performs average pooling operation on all the original features.

In step 3, the enhanced feature vectors are provided. Because the grouping calculated by convolution neural network based on visual priority rules is independent, each feature has its unique independent coefficient. The independent coefficient value corresponding to each independent feature can be obtained in such a manner that the global feature of each independent feature group and the original feature are subjected to integration dot product operation. Meanwhile, for convenience of representation, the independent coefficient values will be normalized. The normalized value that can really be used to calculate the enhanced feature vector further needs function activation. In the present disclosure, the normalized value is processed by scaling and moving, and finally the enhanced feature vector can be obtained by dot product operation.

In step 4, JSON file is provided. The enhanced feature vector can further classify the results by a cross entropy loss function classifier, and the output results are all tag values of face expression information. In order to conveniently store these results in the blockchain, the method of writing JSON fields is used to write the results of expression tag values into JSON files corresponding to short video digital copyright, and these JSON files will only represent the corresponding short video digital copyright information to participate in the subsequent uplink storage operation.

In step 5, Hash value is provided. In order to facilitate the storage of JSON files in the blockchain system, all JSON files will be first uploaded to the file storage server, and at this time, the file storage address pointer set will be obtained. In order to enhance the anti-tampering performance and uniqueness of file uplink storage, the contents of the final uplink storage are video file Hash values, video JSON file Hash values (hereinafter referred to as Index-Hash values) and address pointer value Hash values of the JSON file corresponding to the file storage server (hereinafter referred to as Addresses-Hash value).

In step 6, Hash coding is performed. Hash encryption methods used in all the above steps use SHA256 calculation mode, and Hash collision is not considered by default in the present disclosure, which means that the ciphertext after encryption can be easily calculated from key information of short video digital copyright, but it is almost impossible to deduce any information before encryption through the ciphertext. Therefore, in the present disclosure, the short video digital copyright related information is uploaded in the manner of Hash coding.

Compared with the prior art, the present disclosure has the following advantages.

The short video copyright storage method based on blockchain and expression identification makes full use of the fast and lightweight characteristics of blockchain and Ethereum technology in alliance blockchain, adopts the characteristics of decentralization, security and transparency, exemption from trust, collective maintenance and tamper resistance, integrates P2P communication mode and intelligent contract, cryptography and distributed content storage method, and stores the original resource data of short videos with large files. With the method of “a convolutional neural network based on visual priority rules” based on deep learning technology, the face information tag value JSON file which can uniquely identify short video files is calculated and stored in the alliance blockchain in such a way that the value can be transferred. Short video media storage is perfectly solved by storing it to a file storage server. After the authentication of the node members of the alliance blockchain, the short video media resource data can be traded without compiling a large number of codes. The cost of maintaining the node operation is extremely low, which has a good application value for the copyright management of video media resources of short video producers. The innovation of the present disclosure is embodied in the following aspects.

1) The present disclosure innovatively puts forward the concept of short video key information summary uplink storage. If the short video to be stored is stored in the blockchain as a whole, it is difficult to protect copyright privacy. Because of the limitation of block size, it difficult to store large copyright files. The present disclosure puts forward the idea of extracting key information that can represent and uniquely identify the short video from the short video and storing it in the uplink.

2) The present disclosure innovatively puts forward “a convolution neural network method based on visual priority rules”. Visual priority rule is the most special in the human brain signal processing mechanism. Human beings have the instinct to obtain information by browsing pictures or words quickly. In the process of obtaining information, unconsciously, the parts that need to be focused on will be “anchored”, that is, paying attention to the focus of attention. This mode can effectively avoid redundant information on the basis of visually obtaining more key information. In the present disclosure, the visual priority rule is introduced based on the existing convolutional neural network. “A convolution neural network method based on visual priority rules” is proposed, so that the accuracy of extracting key point features of facial expression is improved.

3) The present disclosure innovatively proposes an method of “short video copyright storage based on blockchain and expression identification”. The traditional copyright management system usually stores video files based on two modes: the video material files are directly stored in the server, and then the corresponding paths of the stored files are written into the database, so that when the number of files increases sharply, the file processing efficiency will decrease exponentially, and the way of storing the file paths cannot fully guarantee the security of the data, and the video content may be modified; video materials are read directly in the way of binary byte stream and video files are written into the fields of the database. Frequent database reading operations will continue to affect the database operation performance. According to the present disclosure, the digital assets can be compressed and described by adopting the deep learning technology, and the application scenarios of the blockchain in the field of digital copyright protection can be greatly increased by reducing the system burden.

### BRIEFT DESCRIPTION OF THE DRAWINGS

FIG. 1 is a structural diagram of a convolutional neural network based on visual priority rules;

FIG. 2 is a structural diagram of a convolutional neural network based on visual priority rules and residual identity;

FIG. 3 is a structural diagram of a residual identity module;

FIG. 4 is an example diagram of the result output calculation flow;

FIG. 5 is a schematic diagram of sampling 30 key points of human face;

FIG. 6 is a schematic diagram of calculating Merkel root value;

FIG. 7 is a schematic diagram of a short video digital copyright storage architecture based on blockchain;

FIG. 8 is a schematic diagram of storing short video copyright registration;

FIG. 9 is a schematic diagram of time-consuming comparison between the traditional storage method and the storage method of the present disclosure;

FIG. 10 is a schematic diagram of memory consumption comparison between the traditional storage method and the storage method of the present disclosure;

FIG. 11 is a radar chart of the characteristic comparison between the existing video copyright storage architecture and the architecture proposed by the present disclosure;

FIG. 12 shows the initial setting values of experimental operation parameters.

### DETAILED DESCRIPTION OF THE EMBODIMENTS

Next, the short video copyright storage method based on blockchain and expression identification will be further explained with the attached drawings.

A short video copyright storage method based on blockchain and expression identification is provided, in which “blockchain” is represented by “the alliance blockchain” in the system, and “expression identification” is “a convolution neural network method based on visual priority” included in the present disclosure, which specifically comprises the following steps.

Step 1: The short video producer uploads the original video file of the face short video to be stored to the system through the client. The video is generally large in size, which is not conducive to direct storage of the blockchain. Therefore, the method of “a convolutional neural network based on visual priority rules” proposed by the present disclosure collects face information in all the pictures of the face short video through the characteristics of the method itself, and semantically analyzes the face information. Then, the complex object of face information is characterized by different parts and different features of the information, and then all the collected sub-features are stored in groups. Complete feature vectors are stored at each independent level.

Step 2: The feature vectors obtained in step 1 are stored in groups and then processed in parallel to improve the processing speed. Then, in order to adjust the importance level of each face part, the weight of the feature vectors is adjusted. The feature vectors stored in groups are operated independently. The present disclosure assumes that there is a feature value in the spatial position of any independent feature group, and then the original feature values in all independent feature groups perform average pooling operation to obtain global features.

Step 3: Dot product operation is performed on all the original features in the integration feature group of the global feature obtained in step 2 to obtain independent coefficients corresponding to each feature value, and normalize these coefficients. Finally, parameters are introduced, the normalized values are scaled and moved, and the SIGMOID function is activated. The activated normalized value and the original feature are subjected to dot product operation to obtain the enhanced feature vector.

Step 4: The enhanced feature vector value output in step 3 is input into a cross entropy loss function classifier, and finally seven types of facial expression tag identification values are output, which are: fear, happiness, anger, disgust, sadness, surprise and normal expression. The present disclosure stores the identified face key information data as the JSON file of the short video content tag value log by writing JSON fields.

Step 5: Aiming at the JSON file of the short video content tag value log which can uniquely identify the digital copyright of the short video output in step 4, the storage address pointer of the file will be obtained after uploading the file to the server, and the video copyright protection system will store the Hash value, the video index value and the corresponding file pointer of the video.

Step 6: The short video copyright storage method based on blockchain and expression identification proposed by the present disclosure adopts deep learning method to extract key frames in order to improve system availability, and takes the key frames of video files as the main basis for video storage and confirmation. The key frames have the characteristics of fast obtaining file information without comparing the original file content, so that their performance loss and physical resource loss can be ignored.

According to the present disclosure, aiming at the copyright key data log file calculated by the method of “a convolution neural network based on visual priority rules”, first, the Hash value of the copyright key data log file is extracted by the SHA256 method, which is similar to the one-to-one correspondence between the database primary key and the file. Therefore, the Hash value of the log file is stored in the blockchain as the unique identifier of the file.

The short video copyright storage method based on blockchain and expression identification further comprises: prior to step 1, the alliance chain members log in for authentication. The member nodes of the alliance chain initiate a login request to the alliance blockchain through their own unique private keys. If the login verification fails, the alliance blockchain automatically rejects the login request of the node. If the login verification passes, the passing result is fed back to the node requesting authentication, and the node is allowed to enter and initiate subsequent operations.

In step 1, short video key face information is provided. Any short video work that can be normally circulated in broadcast TV network, mobile Internet and 5G network occupies a large digital space, so it is redundant to directly protect its own uplink copyright. Moreover, in view of the directionality of the present disclosure, the clearer the face information, the more preponderant the more storage details of the face picture in all frames of the video. The facial expression in the video is identified by the deep learning method, and the face information in the video is simply described, so as to make a reasonable prediction of the video content. Thereafter, the form of “short video key face information” is used as an effective parameter for the alliance chain to store data.

In step 2, feature vectors are provided. In order to improve the efficiency of distributed computing, each independent grouping calculated by convolution neural network based on visual priority rules can process its sub-features in parallel, but each sub-feature has slightly different importance when fully expressing facial expression information. Therefore, adjusting the sub-feature vector can modify its importance. Because the present disclosure first assumes that each feature group has an original feature, in order to accurately describe these features, the present disclosure performs average pooling operation on all the original features.

In step 3, the enhanced feature vectors are provided. Because the grouping calculated by convolution neural network based on visual priority rules is independent, each feature has its unique independent coefficient. The independent coefficient value corresponding to each independent feature can be obtained in such a manner that the global feature of each independent feature group and the original feature are subjected to integration dot product operation. Meanwhile, for convenience of representation, the independent coefficient values will be normalized. The normalized value that can really be used to calculate the enhanced feature vector further needs function activation. In the present disclosure, the normalized value is processed by scaling and moving, and finally the enhanced feature vector can be obtained by dot product operation.

In step 4, JSON file is provided. The enhanced feature vector can further classify the results by a cross entropy loss function classifier, and the output results are all tag values of face expression information. In order to conveniently store these results in the blockchain, the method of writing JSON fields is used to write the results of expression tag values into JSON files corresponding to short video digital copyright, and these JSON files will only represent the corresponding short video digital copyright information to participate in the subsequent uplink storage operation.

In step 5, Hash value is provided. In order to facilitate the storage of JSON files in the blockchain system, all JSON files will be first uploaded to the file storage server, and at this time, the file storage address pointer set will be obtained. In order to enhance the anti-tampering performance and uniqueness of file uplink storage, the contents of the final uplink storage are video file Hash values, video JSON file Hash values (hereinafter referred to as Index-Hash values) and address pointer value Hash values of the JSON file corresponding to the file storage server (hereinafter referred to as Addresses-Hash value).

In step 6, Hash coding is performed. Hash encryption methods used in all the above steps use SHA256 calculation mode, and Hash collision is not considered by default in the present disclosure, which means that the ciphertext after encryption can be easily calculated from key information of short video digital copyright, but it is almost impossible to deduce any information before encryption through the ciphertext. Therefore, in the present disclosure, the short video digital copyright related information is uploaded in the manner of Hash coding.

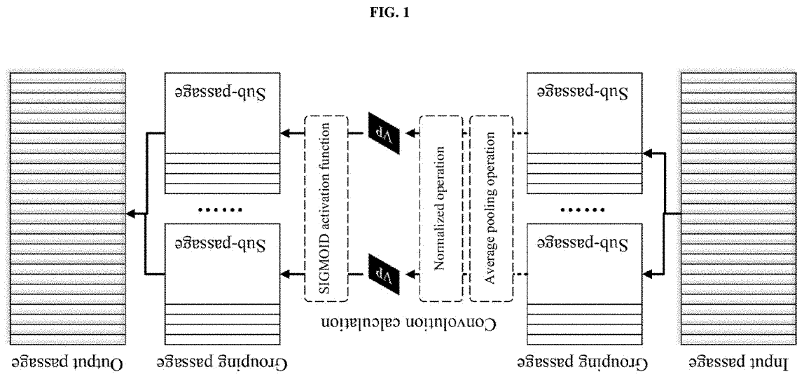

As shown in FIG. 1, the convolutional neural network structure based on visual priority rules in the short video copyright storage method based on blockchain and expression identification includes the following steps.

1) Convolution neural network collects different parts of face semantic sub-features and hierarchical structure features through its own features, and then characterizes complex objects, in which all sub-features are stored in feature vectors of each independent level in groups.

2) In the convolutional neural network based on visual priority rules, the sub-features in each group are processed in parallel.

3) The visual priority rule module can adjust the importance of each sub-feature by adjusting the weight.

4) The calculation of visual priority rules is operated separately for each group. It is first assumed that there is a feature in each spatial position of a feature group. Second, the original features in the feature group perform average pooling operation. Then, the global features in the feature group and the original features are subjected to integration dot product operation to obtain the independent coefficients corresponding to each feature and normalize them.

5) Parameters are introduced, the normalized values are scaled and moved, and the SIGMOID function is activated. Finally, the activated normalized value and the original feature are subjected to dot product operation to obtain the enhanced feature vector.

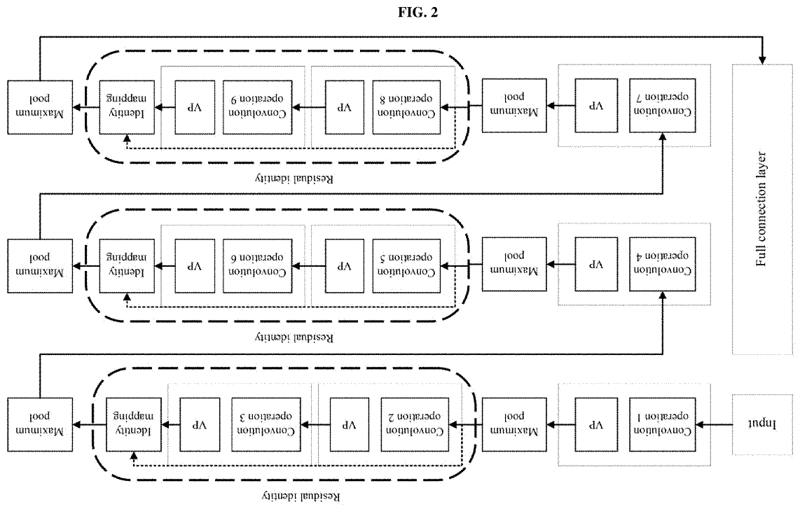

As shown in FIG. 2, in the short video copyright storage method based on blockchain and expression identification, the convolutional neural network structure based on visual priority rules and residual equivalence comprises the following steps.

1) The features of input data are extracted. In convolutional neural network, the first layer generally does not extract high-level features but only some lower-level features, and the complexity level of features will increase correspondingly with the increase of convolution layers, so that neural network with multiple convolution layers can obtain more accurate features after iteration. A core is set as a convolution kernel of convolutional neural network, whose size is X*Y, bias is its offset, fun is the activation function, input and output are input and output respectively, and the sizes of input and output are both M*N, wherein the proposed convolution operation formula is shown in formula (1):

output_{MN}=fun(Σₓ₌₀^{X-1}Σ_{y=0}^{Y-1}input_{m+y,n+x}core_{yx}+bias)

(0≤m≤M,0≤n≤N) (1)

2) In order to compress the input feature map, the present disclosure proposes an average pooling operation, which is a non-linear down-sampling operation method. The size of the compressed feature map will be significantly reduced, and there is no over-fitting problem in the average pooling operation. If the down-sampling layer is set as sampling_{down}, and maximum pooling calculation is used, the definition of maximum pooling is shown in formula (2).

sampling_{down}=max(sampling_{down-1}) (2)

3) In order to increase the expression ability and nonlinear mapping ability of a convolutional neural network, ELU activation function is adopted, no saturation value of the activation function is controlled, and count is set as a constant, wherein the expression of the activation function is shown in formula (3).

$$E L U ( x ) = \{ \begin{matrix}x , x > 0 \\ count ( exp ( x ) - 1 ) , x \leq 0\end{matrix} ; \qquad ( 3 )$$

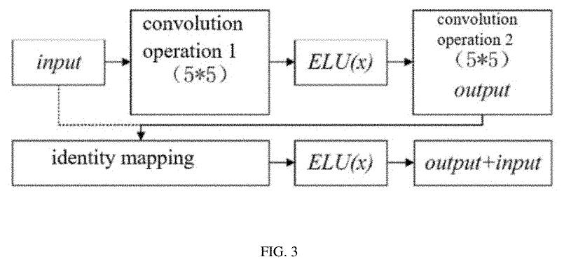

4) The facial expression identification method of the convolutional neural network based on visual priority rules provided by the present disclosure adds residual identity blocks in order to increase identity mapping and enrich feature learning in the network, and the module is also combined with the visual priority rule module to ensure accurate extraction of subtle expressions and key expression features. As shown in FIG. 3, the residual identity module structure in the short video copyright storage method based on blockchain and expression identification comprises the following steps.

1) The input is set as the input value of the residual identity block, the activation function is set as ELU(x), and the result output after convolution operation is set as output.

2) The convolution operation scale is 5*5 and the final output is input+output.

3) Identity mapping is added before activating the function for the second time.

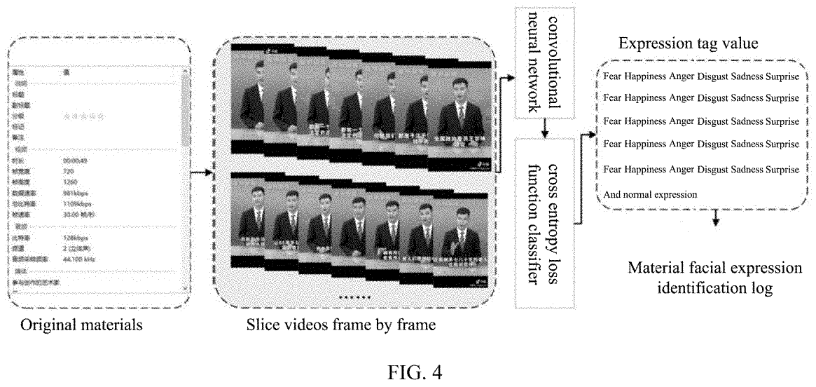

As shown in FIG. 4, an example of the result output calculation flow in the short video copyright storage method based on blockchain and expression identification comprises the following steps.

1) The input of a short video copyright storage method based on blockchain and facial expression identification provided by the present disclosure is an image after short video is read frame by frame.

2) After calculation by convolutional neural network, a cross entropy loss function classifier is input, and the identification values of seven types of expression tags are finally output, which are fear, happiness, anger, disgust, sadness, surprise and normal expression.

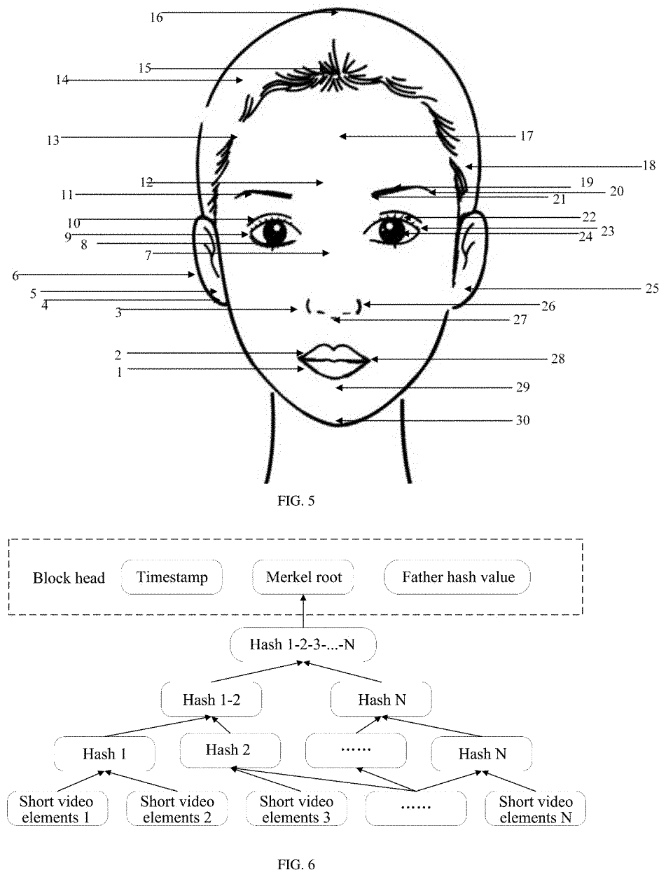

As shown in FIG. 5, the sampling 30 key points of human face in the short video copyright storage method based on blockchain and expression identification include:

1) 30 identified basic key points.

2) The key points defined in the present disclosure are lip thickness, lip width, nose thickness, earlobe thickness, earlobe width, auricle width, nose height, lower eyelid width, eye corner width, eyelash width, right eyebrow width, eyebrow spacing, right sideburns height, hair color, middle hair width, head height, forehead color, left sideburns width, left eyebrows width, eyebrow tip height, eyebrow tail height, single-edged and double-edged eyelids, fish tail width, eyeball color, ear ornaments, nose width, philtrum depth, lip color, lower lip thickness and chin width.

As shown in FIG. 6, calculating the Merkel root value in the short video copyright storage method based on blockchain and expression identification comprises the following steps.

1) The Hash value of the key information label value log file of facial expression identification is stored in the blockchain as the unique identifier of the file.

2) If the length of a video file to be stored exceeds the specified duration (5 min), the system will automatically divide it into a single short video group with a duration of 5 min.

3) The elements in the group will output logs respectively, and the total Hash value will be calculated in the form of Merkel tree as the Merkel root value of the long video to be written into the block.

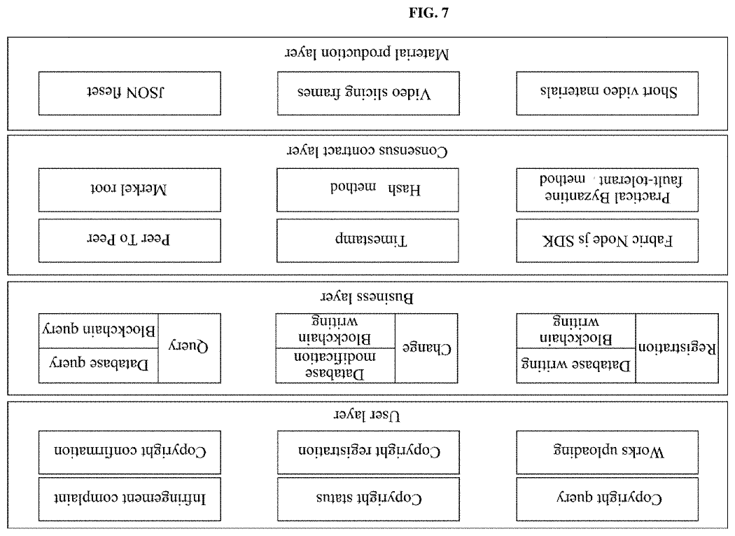

As shown in FIG. 7, the schematic diagram of a short video digital copyright storage architecture based on blockchain in the short video rights storage method based on blockchain and expression identification comprises the following steps.

1) Hash collision occurs, that is, when a suspected infringing video is detected, the short video digital copyright storage architecture based on blockchain proposed by the present disclosure takes video digital copyright key frames as the judgment basis, that is, the storage architecture changes the uplink storage of short video works into the uplink storage of key frame information, that is, the contents stored in the block, such as “Hash values of multiple videos”, are correspondingly changed into “Hash values of multiple key frames of one video”.

2) In addition, the number of key frames is adjusted by setting thresholds, and different key frame selection bases are set based on different review standard mechanisms, so that the robustness and efficiency of the storage architecture are improved.

3) The short video digital copyright storage architecture based on blockchain consists of a material production layer, a consensus contract layer, a business layer and a user layer from bottom to top.

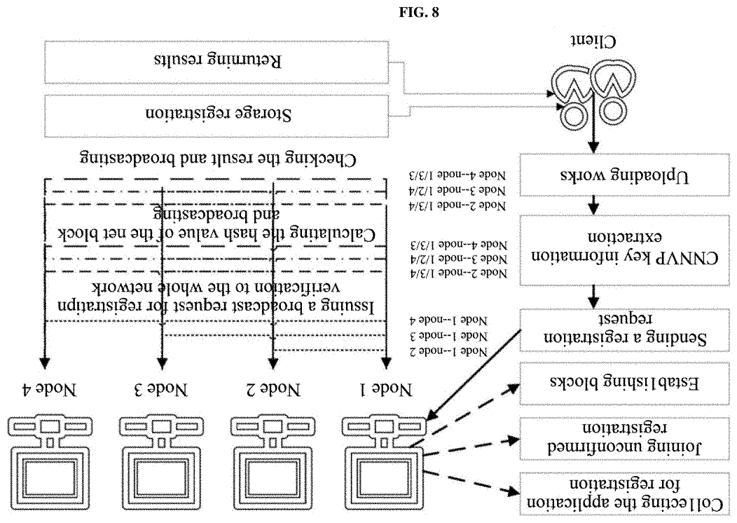

As shown in FIG. 8, the schematic diagram of storing short video digital copyright registration in the short video copyright storage method based on blockchain and expression identification comprises the following steps.

1) When the short video digital copyright storage architecture based on blockchain stores the copyright of short video key information, first, original materials are uploaded to an external client through a framework. Second, the facial expression identification mechanism of convolutional neural network based on visual priority rule extracts key frame data, constructs a new block according to the key data list and issues a broadcast to the whole network, and stores the personal information of a user and short video copyright information on the server simultaneously.

2) The client automatically initiates the application for registration into the chain and sends this application to the first node, and after collecting the application for registration, joining the unconfirmed registration and establishing the block, the first node issues a broadcast to the whole network and requests the whole network to carry out registration verification.

3) After receiving the new block issued by the first node, the second node, the third node and the fourth node calculate the hash value of the new block and issue a broadcast to the whole network to complete the pre-registration, respectively.

4) Four nodes receive and check the hash value of the new block broadcasted by each other, respectively. If the hash value of the received new block calculated by a certain neighbor node is equal to the hash value of the new block calculated by itself before issuing a broadcast, it is regarded as passing the registration check, otherwise it fails.

5) Finally, each independent node broadcasts the verification result to other nodes after completing the registration verification of the hash value of the new block. According to Byzantine fault-tolerant method, each node working normally should receive and verify the registration verification information at least twice as much as the attack information. After each node receives the registration verification information of other nodes, the short video copyright registration confirmation letter is stored and is automatically sent to the client, and the primary registration process ends.

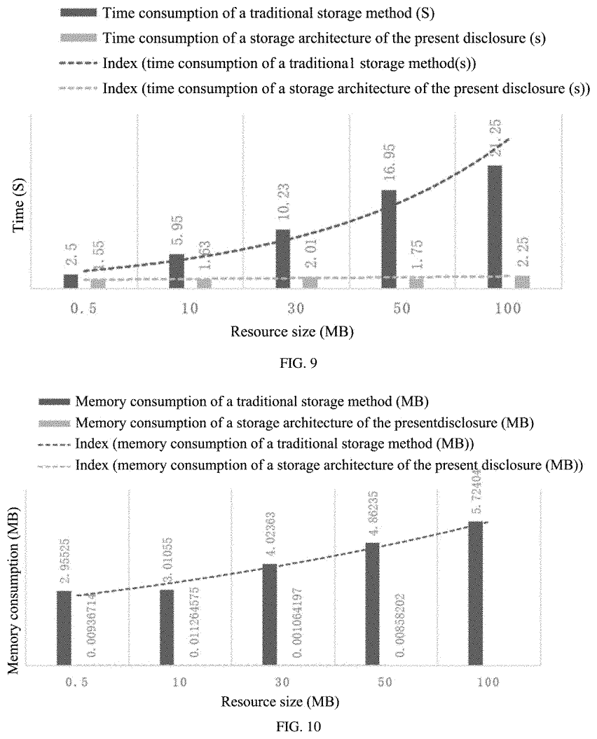

As shown in FIG. 9 and FIG. 10, the time consumption comparison and the memory consumption comparison between the traditional storage method and the storage method of the present disclosure in the short video copyright storage method based on blockchain and expression identification comprises the following steps.

1) Original video files with sizes of about 0.5 MB, LOMB, 30 MB, 50 MB and 100 MB are selected from a material library, respectively, and 5 short videos are stored for 50 times in a traditional storage method and a storage method of the present disclosure, respectively.

2) The experimental results show that the storage method proposed by the present disclosure is far less than the consumption of the traditional method in terms of time consumption and resource consumption.

3) The consumption in the traditional storage method in terms of time consumption and resource consumption increases exponentially with the increase of video resources.

4) The storage method provided by the present disclosure has strong robustness and stability, and has no obvious change.

5) Therefore, aiming at the uplink storage of short video copyright resources, the storage method proposed by the present disclosure is more suitable for the change of file size.

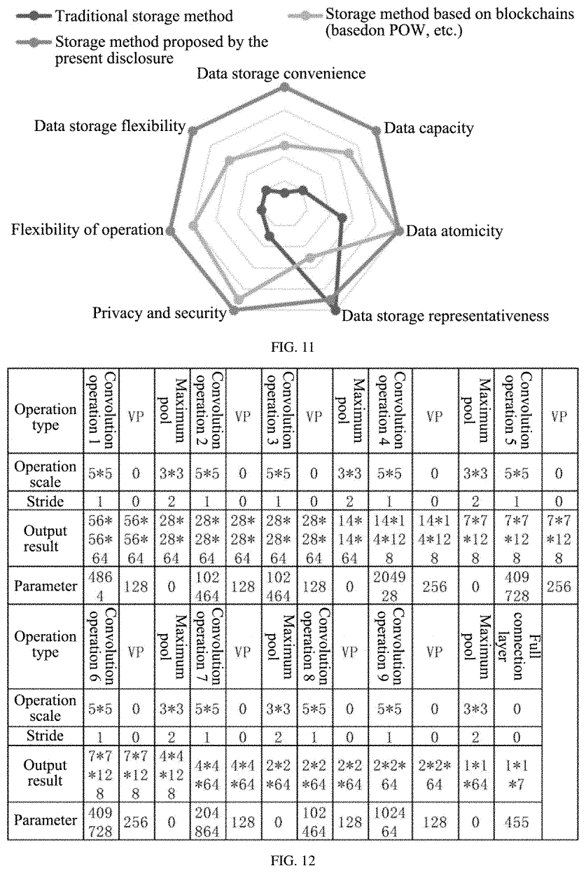

As shown in FIG. 11, a radar chart of the characteristic comparison between the existing video copyright storage architecture and the architecture proposed by the present disclosure in the short video copyright storage method based on blockchain and expression identification comprises the following steps.

1) The present disclosure compares the existing traditional copyright storage method, the blockchain copyright storage method based on POW consensus mechanism and the blockchain copyright storage method based on PBFT and CNNVP proposed by the present disclosure in detail from the aspects of data storage convenience, data capacity, data atomicity (uniqueness), data storage representativeness, data privacy and security, system operation flexibility and data storage flexibility.

2) The comparison results show that the proposed method is efficient.

As shown in FIG. 12, the initial setting values of operation parameters in the short video copyright storage method based on blockchain and expression identification comprises:

1) operation type, operation scale, stride, output result and parameters;

2) the operation type comprises convolution operation, visual priority rule, maximum pool operation and full connection layer operation;

3) the operation scale comprises: 0, 3*3, 5*5;

4) the output result comprises: 1*1*7, 1*1*64, 2*2*64, 4*4*64, etc.;

5) the parameter comprises: 0, 128, 256, etc.

The above is only an illustration of an example of the present disclosure, rather than limiting the present disclosure. Those skilled in the art should realize that any transformation and modification made to the present disclosure will fall into the protection scope of the present disclosure.

What is claimed is:

1. A short video copyright storage method based on blockchain and expression identification, comprising the steps of:
Step 1: identifying facial expressions in face short videos using convolution neural network method based on visual priority rules, uploading short video works by a client, extracting facial expression features of the whole short video, and generating JSON file of a content tag value log capable of uniquely identifying the short video;
Step 2: using the short video digital copyright storage method based on blockchain and facial expression identification to store the JSON file of the content tag value log of the short video generated in step 1 into the alliance blockchain;
Step 3: sending a registration request to the first node in the alliance blockchain responsible for collecting registration applications, joining unconfirmed registration lists and building blocks, wherein the first node issues a broadcast request for registration verification to the whole network;
Step 4: after the available nodes of the whole network receive the request from the first node, calculating the hash value of the new block first, and then issuing the broadcast request for hash value check to the whole network;
Step 5: after the available nodes of the whole network receive the hash value of the new block calculated in step 4, checking the hash value first, then broadcasting its own check result to the whole network, storing and registering after being confirmed for the rule by the fault-tolerant method in the whole network, and finally returning the results to the client.

2. The short video copyright storage method based on blockchain and expression identification according to claim 1, further comprising: prior to step 1, the alliance chain members log in for authentication.

3. The short video copyright storage method based on blockchain and expression identification according to claim 1, wherein the alliance chain members log in for authentication, specifically comprising:
the member nodes of the alliance chain initiate a login request to the alliance blockchain through their own unique private keys, if the login verification fails, the alliance blockchain automatically rejects the login request of the node to the trading system; if the login verification passes, the passing result is fed back to the node requesting authentication, and the node is allowed to enter the short video digital copyright storage system and initiate subsequent operations.

4. The short video copyright storage method based on blockchain and expression identification according to claim 1, wherein in step 1, identifying facial expressions in face short videos using convolution neural network method based on visual priority rules specifically comprises:
A) extracting the features of input data, setting a core as a convolution kernel of a convolutional neural network, whose size is X*Y, where X*Y represents the size of the convolution kernel, bias is its offset, fun is the activation function, input and output are input and output respectively, and the sizes of input and output are both M*N, wherein the proposed convolution operation formula is shown in formula (1):
$${output}_{M N} = fun ( {\sum }_{x = 0}^{X - 1} {\sum }_{y = 0}^{Y - 1} {input}_{m + y , n + x} c o r {e}_{y x} + bias ) \\ ( 0 \leq m \leq M , 0 \leq n \leq N ) \qquad ( 1 )$$
B) performing average pooling operation, and setting the down-sampling layer as sampling_{down}, and using maximum pooling calculation, wherein the definition of maximum pooling is shown in formula (2);
sampling_{down}=max(sampling_{down-1}) (2)
where sampling_{down-1} represents the previous sampling layer of the down-sampling layer;
C) using the ELU activation function, controlling no saturation value of the activation function, and setting count as a constant, wherein the expression of the activation function is shown in formula (3);
$$E L U ( x ) = \{ \begin{matrix}x , x > 0 \\ count ( exp ( x ) - 1 ) , x \leq 0\end{matrix} ; \qquad ( 3 )$$
where ELU(x) represents the activation function based on the independent variable x, count in count(exp(x)-1) is a constant, and count in count(exp(x)-1) is used to control the saturation value of the activation function.

5. The short video copyright storage method based on blockchain and expression identification according to claim 1, wherein in step 1, the JSON file of the content tag value log of short videos consists of the following facial feature information: lip thickness, lip width, nose thickness, earlobe thickness, earlobe width, auricle width, nose height, lower eyelid width, eye corner width, eyelash width, right eyebrow width, eyebrow spacing, right sideburns height, hair color, middle hair width, head height, forehead color, left sideburns width, left eyebrows width, eyebrow tip height, eyebrow tail height, single-edged and double-edged eyelids, fish tail width, eyeball color, ear ornaments, nose width, philtrum depth, lip color, lower lip thickness and chin width, and its identification value consists of the following expression tags: fear, happiness, anger, disgust, sadness, surprise and normal expression.

6. The short video copyright storage method based on blockchain and facial expression identification according to claim 1, wherein in step 2, using the short video digital copyright storage method based on blockchain and facial expression identification to store the JSON file of the content tag value log of the short video generated in step 1 into the alliance blockchain comprises:
a) uploading original materials to an external client through a framework;
b) the facial expression identification mechanism of a convolutional neural network based on visual priority rule extracting key frame data, constructing a new block according to the key data list and issuing a broadcast to the whole network, and storing the personal information of a user and short video copyright information on the server simultaneously;
c) the client automatically initiating the application for registration into the chain and sending this application to the first node, after the first node collects the application for registration, joins the unconfirmed registration and establishes the block, issuing a broadcast to the whole network and requesting the whole network to carry out registration verification;
d) after receiving the new block issued by the first node, the second node, the third node and the fourth node calculating the hash value of the new block and issuing a broadcast to the whole network to complete the pre-registration, respectively;
e) four nodes receiving and checking the hash value of the new block broadcasted by each other, respectively;
if the hash value of the received new block calculated by a certain neighbor node is equal to the hash value of the new block calculated by itself before issuing a broadcast, it is regarded as passing the registration check, otherwise it fails; and
f), each independent node broadcasts the verification result to other nodes after completing the registration verification of the hash value of the new block, according to Byzantine fault-tolerant method, each node working normally should receive and verify the registration verification information at least twice as much as the attack information, after each node receives the registration verification information of other nodes, the short video copyright registration confirmation letter is stored and is automatically sent to the client, and the primary registration process ends.

7. The short video copyright storage method based on blockchain and expression identification according to claim 1, wherein in step 4, the hash value of the new block is calculated by the hash function SHA256 method.

8. The short video copyright storage method based on blockchain and expression identification according to claim 1, wherein in step 5, the fault-tolerant method is a practical Byzantine fault-tolerant method.
